(19) United States
(12) Patent Application Publication
(10) Pub. No.: US 2012/0068652 A1
(43) Pub. Date: Mar. 22, 2012

(54) FAN DRIVE CIRCUIT FOR ELECTRONIC DEVICE

(75) Inventor: YONG-ZHAO HUANG, Shenzhen (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/010,789

(22) Filed: Jan. 21, 2011

(30) Foreign Application Priority Data
Sep. 17, 2010 (CN) 201010285084.X

(51) Int. Cl. H02P 7/00

(52) U.S. Cl. 318/472

(57) ABSTRACT

A fan drive circuit for driving a fan used in an electronic device to rotate includes a heat detector, a control unit, an integrating circuit, a regulating circuit; and a power supply. The power supply cooperates with the regulating circuit to drive the fan to rotate, the control unit detects the temperature of the one or more components of the electronic device using the heat detector and cooperates with the integrating circuit to generate a speed control voltage that changes with change of the temperature, and the speed control voltage is input to the regulating circuit to regulate a rotation rate of the fan.

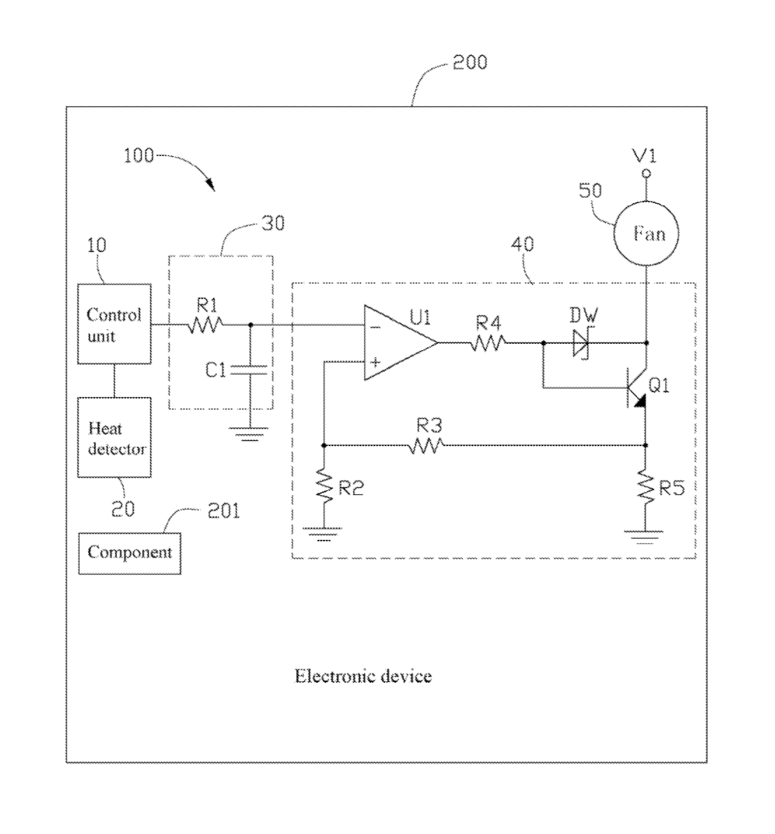

### BACKGROUND

1. Technical Field

The present disclosure relates to electronic devices, and particularly to a fan drive circuit for electronic devices.

2. Description of Related Art

Many electronic devices, such as computers and automobile electronic systems, use fans for dissipating unwanted heat. However, most fans used in the electronic devices can only rotate at invariable speeds. Thus, these fans may be unable to effectively dissipate unwanted heat when the electronic devices are excessively hot, and may waste electric power when the electronic devices are not very hot.

Therefore, there is room for improvement within the art.

### BRIEF DESCRIPTION OF THE DRAWINGS

Many aspects of the present fan drive circuit can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

The FIGURE is a circuit diagram of a fan drive circuit, according to an exemplary embodiment.

### DETAILED DESCRIPTION

The figure shows a fan drive circuit 100, according to an exemplary embodiment. The fan drive circuit 100 is used in an electronic device 200, such as a computer or an automobile electronic system, for driving a fan 50 of the electronic device 200, thereby generating air flow to dissipate unwanted heat generated in the electronic device 200. The fan drive circuit 100 includes a control unit 10, a heat detector 20, an integrating circuit 30, a regulating circuit 40, and a power supply V1. The heat detector 20, the control unit 10, the integrating circuit 30, and the regulating circuit 40 are connected in series. The regulating circuit 40 and the power supply V1 are both connected to the fan 50. The power supply V1 can be a general power supply of the electronic device 200 for providing power to the fan 50.

The heat detector 20 includes a thermistor or other temperature sensors. In use, the heat detector 20 can measure a value of a temperature in the electronic device 200 and generate an electronic signal corresponding to the temperature value. The control unit 10 can be a pulse width modulation (PWM) controller. In use, the control unit 10 receives the electric signal corresponding to the temperature value from the heat detector 20 to detect the temperature in the electronic device 200 (or one or more components 201 of the electronic device 200), and generates a pulse signal corresponding to the temperature. The control unit 10 can also regulate a duty ratio of the pulse signal according to the temperature. In this embodiment, the control unit 10 increases the duty ratio of the pulse signal when the temperature increases, and decreases the duty ratio of the pulse signal when the temperature decreases.

The integrating circuit 30 includes a resistor R1 and a capacitor C1. One end of the resistor R1 is connected to the control unit 10 to receive the pulse signal generated by the control unit 10, and another end of the resistor R1 is connected to both a terminal of the capacitor C1 and the regulating circuit 40. Another terminal of the capacitor C1 is grounded. In this way, the integrating circuit 30 can receive the pulse signal and integrate the pulse signal to generate a speed control voltage on the end of the resistor R1 that is connected to both the capacitor C1 and the regulating circuit 40, thereby inputting the speed control voltage to the regulating circuit 40. According to the characteristics of integrating circuit, the speed control voltage generated by integrating the pulse signal will increase when the duty ratio of the pulse signal increases, and will decrease when the duty ratio of the pulse signal decreases.

The regulating circuit 40 includes an operational amplifier U1, a transistor Q1, a zener diode DW, and four resistors R2, R3, R4, R5. The operational amplifier U1 has an inverting input pin, a non-inverting input pin, and an output pin. The inverting input pin is connected to the end of the resistor R1 that is connected to the capacitor C1, thereby receiving the speed control voltage generated by the integrating circuit 30. One end of the resistor R2 is connected to the non-inverting input pin and another is grounded. One end of the resistor R3 is connected to both the non-inverting input pin and the end of the resistor R2 that is connected to the non-inverting pin, and another end of the resistor R3 is connected to the emitter of the transistor Q1. One end of the resistor R4 is connected to the output pin, and another is connected to both an anode of the zener diode DW and a base of the transistor Q1. One end of the resistor R5 is connected to the emitter of the transistor Q1 and another is grounded. A cathode of the zener diode DW and a collector of the transistor Q1 are both connected to the fan 50.

When the fan drive circuit 100 is used, a work voltage provided by the power supply V1 is applied to the fan 50. The work voltage is greater than a breakdown voltage of the zener diode DW and an on-voltage of the transistor Q1. At the same time, the heat detector 20 detects a value of a temperature in the electronic device 200 (or one or more components 201 of the electronic device 200) and generates an electronic signal corresponding to the temperature value. The control unit 10 receives the electronic signal from the heat detector 20 to detect the temperature, and generates a pulse signal corresponding to the temperature.

The pulse signal is input to the integrating circuit 30. The integrating circuit 30 integrates the pulse signal to generate a speed control voltage and inputs the speed control voltage to the inverting pin of the operational amplifier U1.

The speed control voltage is applied to the base of the transistor Q1 through the operational amplifier U1 and the resistor R4. If the speed control voltage is greater than or equal to the on-voltage of the transistor Q1, the transistor Q1 is switched on by the speed control voltage, such that the collector and emitter of the transistor Q1 are connected to each other. Thus, the fan 50 is connected to the ground through the transistor Q1 and the resistor R5. The work voltage generates a current passing through the fan 50 to drive the fan 50 to rotate. If the speed control voltage is lower than the on-voltage of the transistor Q1 and is unable to switch the transistor Q1 on, the work voltage is applied on the cathode of the zener diode DW through the fan 50 and breaks down the zener diode DW. Thus, the work voltage is applied to the base of the transistor Q1 through the zener diode DW and switches the transistor Q1 on. In this way, the fan 50 is still connected to the ground through the transistor Q1 and the resistor R5, and the work voltage generates the current passing through the fan 50 to drive the fan 50 to rotate.

When the transistor Q1 is switched on, the resistor R4, the zener diode DW, the collector and the emitter of the transistor Q1, and the resistor R3 cooperatively form a feedback path connecting the output pin to the non-inverting input pin. Due to feedback, voltages on the inverting pin and the non-inverting pin are substantially equal to each other (i.e., a virtual short circuit is formed between the inverting pin and the non-inverting pin). Therefore, the voltage on the non-inverting pin is substantially equal to the speed control voltage. Furthermore, since the emitter of the transistor Q1 is also connected to the ground through the resistors R3, R2, the work voltage generates a current passing through the resistors R3, R2. According to known characteristics of operational amplifiers, a current input to the non-inverting pin of the operational amplifier U1 is close to zero. Therefore, despite one end of the resistor R3 connected to both the resistor R2 and the non-inverting pin of the operational amplifier U1, the current passing the resistor R3 is substantially equal to the current passing through the resistor R2.

Furthermore, the speed control voltage can be used to regulate the current passing through the fan 50. Particularly, a value of the speed control voltage indicated as Ui, a value of a voltage on the emitter of the transistor Q1 indicated as Ue, a value of the current passing through the fan 50 indicated as I, resistances of the resistors R2, R3, R5 respectively indicated as R₂, R₃, R₅, respectively, relations between these parameters can be described as follows.

As above detailed, when the fan drive circuit 100 is used, the voltages on the inverting pin and the non-inverting pin are substantially equal to each other. Thus, values on the inverting pin and the non-inverting pin are both the value of the speed control voltage (Ui). Additionally, the current passing the resistor R3 is substantially equal to the current passing through the resistor R2 (i.e., a current having a value that equals to Ui/R₂). According to aforementioned relations, the relations between these parameters can be described as these formulas:

I=Ue/R₅+Ui/R₂

Ue=Ui+Ui×R₃/R₂

Thus, it can be inferred that:

I=Ui×(1/R₅+R₃/R₂×R₅+1/R₂)

According to above formulas, I is directly proportional to Ui. Therefore, when the temperature of the electronic device 200 increases, the control unit 10 detects the increase of the temperature using the heat detector 20, and correspondingly increases the duty ratio of the pulse signal sent to the integrating circuit 31. Thus, the speed control voltage generated by the integrating circuit 31 increases, and then the current passing through the fan 50 correspondingly increases, such that the fan 50 is driven to rotate in a higher rate and generates greater air flow to effectively dissipate unwanted heat in the electronic device 200. When the temperature of the electronic device 200 decreases, the control unit 10 correspondingly decreases the duty ratio of the pulse signal sent to the integrating circuit 31. Thus, the speed control voltage and the current passing through the fan 50 correspondingly decrease, and the fan 50 is driven to rotate at a lower rate for conserving electric power.

The present fan drive circuit 100 can automatically regulate the rotation rate of the fan 50 when the temperature in the electronic device 200 (or one or more components 201 of the electronic device 200) changes. Compared with typical electronic devices using fans, electronic devices using the fan drive circuit 100 can effectively dissipate unwanted heat when the electronic devices are excessively hot, and conserve electric power when the electronic devices are not very hot.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A fan drive circuit for driving a fan used in an electronic device to rotate, comprising:
a heat detector that measures a temperature of one or more components of the electronic device;
a control unit;
an integrating circuit;
a regulating circuit electrically connected to the integrating circuit and the fan; and
a power supply connected to the fan; wherein the power supply cooperates with the regulating circuit to drive the fan to rotate, the control unit detects the temperature of the one or more components using the heat detector and cooperates with the integrating circuit to generate a speed control voltage that changes with change of the temperature of the one or more components, and the speed control voltage is input to the regulating circuit to regulate a rotation rate of the fan.

2. The fan drive circuit as claimed in claim 1, wherein the control unit generates a pulse signal corresponding to the temperature of the one or more components, and the integrating circuit receives the pulse signal and integrates the pulse signal to generate the speed control voltage.

3. The fan drive circuit as claimed in claim 2, wherein the control unit increases the duty ratio of the pulse signal when the temperature of the one or more components increases, and decreases the duty ratio of the pulse signal when the temperature of the one or more components decreases.

4. The fan drive circuit as claimed in claim 3, wherein the integrating circuit integrates the pulse signal to generate the speed control voltage.

5. The fan drive circuit as claimed in claim 4, wherein the integrating circuit includes a first resistor and a capacitor, one end of the resistor connected to the control unit to receive the pulse signal, another end of the resistor connected to both a terminal of the capacitor and the regulating circuit, another terminal of the capacitor grounded, and the speed control voltage generated on the end of the first resistor that is connected to both the capacitor and the regulating circuit.

6. The fan drive circuit as claimed in claim 5, wherein the regulating circuit includes an operational amplifier, a transistor, a zener diode, a second resistor, a third resistor, a fourth resistor, and a fifth resistor; the operational amplifier having an inverting input pin, a non-inverting input pin, and an output pin, the inverting input pin connected to the end of the first resistor that is connected to the capacitor to receive the speed control voltage; the second resistor having one end connected to the non-inverting input pin and another end grounded; the third resistor having one end connected to both the non-inverting input pin and the end of the second resistor that is connected to the non-inverting pin, and another end connected to an emitter of the transistor; the fourth resistor having one end connected to the output pin and another end connected to both an anode of the zener diode and a base of the transistor; the fifth resistor having one end connected to the emitter of the transistor and another end grounded; a cathode of the zener diode and a collector of the transistor both connected to the fan.

7. The fan drive circuit as claimed in claim 6, wherein when the speed control voltage is applied to the base of the transistor through the operational amplifier and the fourth resistor, if the speed control voltage is greater than or equal to an on-voltage of the transistor, the transistor is switched on by the speed control voltage, thereby generating a current passing through the fan and driving the fan to rotate; if the speed control voltage is lower than the on-voltage of the transistor, a voltage provided by the power supply breaks down the zener diode and is applied to the base of the transistor to switches the transistor on, thereby generating the current passing through the fan and driving the fan to rotate.

8. The fan drive circuit as claimed in claim 7, wherein when the speed control voltage changes, the current passing through the fan and driving the fan to rotate is changed according to the speed control voltage, and thus the rotation rate of the fan is regulated.

9. The fan drive circuit as claimed in claim 8, wherein a value of the speed control voltage is directly proportional to a value of a current passing through the fan for driving the fan to rotate.
